(19) United States
(12) Patent Application Publication
(10) Pub. No.: US 2021/0183591 A1
(43) Pub. Date: Jun. 17, 2021

(54) Childproof Light Switch Cover Apparatus

(71) Applicant: Thomas Jaso, Winlock, WA (US)

(72) Inventor: Thomas Jaso, Winlock, WA (US)

(21) Appl. No.: 16/710,628

(22) Filed: Dec. 11, 2019

(51) Int. Cl. H01H 9/28; H01H 9/06; F21V 25/00; F21V 23/04

(52) U.S. Cl. CPC H01H 9/287; F21V 23/04; F21V 25/00; H01H 9/06

(57) ABSTRACT

A childproof light switch cover apparatus for preventing a child from accessing a light switch includes a cover plate configured to engage a standard light switch box. The cover plate has a switch aperture extending therethrough that is dimensioned to receive a switch of the standard light switch box. A tubular extension is coupled to the cover plate around the switch aperture. A locking tab is coupled to a sidewall of the extension adjacent an outer threaded portion of the extension. A cap has a main portion and a flanged bottom portion. The cap is threadingly engageable with the outer threaded portion of the extension and the flanged bottom portion is selectively engageable with the locking tab to prevent the cap from rotating to disengage from the extension. The locking tab is substantially flexible to be depressed and to allow the cap to rotate freely.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to light switch cover plates and more particularly pertains to a new light switch cover plate for preventing a child from accessing a light switch.

### (2) Description of Related Art Including Information Disclosed Under 37 CFR 1.97 and 1.98

The prior art relates to light switch cover plates. Many existing cover plates designed to childproof a light switch are limited for use with a low profile rocker switch. Others employ a large, bulky cover that covers most or all of the cover plate. Of the few existing covers that employ a threaded cap, the childproofing mechanism is a simple push-and-turn or squeeze-and-turn cap that is easily overcome by some children.

### BRIEF SUMMARY OF THE INVENTION

An embodiment of the disclosure meets the needs presented above by generally comprising a cover plate configured to engage a standard light switch box. The cover plate has a switch aperture extending therethrough that is dimensioned to receive a switch of the standard light switch box. A tubular extension is coupled to the cover plate around the switch aperture. A locking tab is coupled to a sidewall of the extension adjacent an outer threaded portion of the extension. A cap has a main portion and a flanged bottom portion. The cap is threadingly engageable with the outer threaded portion of the extension and the flanged bottom portion is selectively engageable with the locking tab to prevent the cap from rotating to disengage from the extension. The locking tab is substantially flexible to be depressed and to allow the cap to rotate freely.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a childproof light switch cover apparatus according to an embodiment of the disclosure.

FIG. 2 is a front elevation view of an embodiment of the disclosure.

FIG. 3 is a rear elevation view of an embodiment of the disclosure.

FIG. 4 is a side elevation view of an embodiment of the disclosure.

FIG. 5 is a side elevation view of an embodiment of the disclosure.

### DETAILED DESCRIPTION OF THE INVENTION

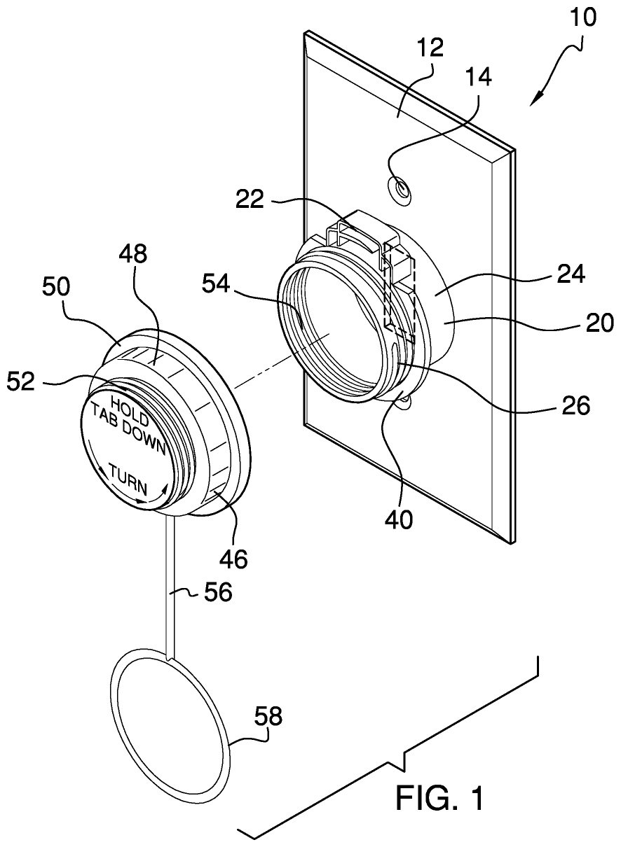

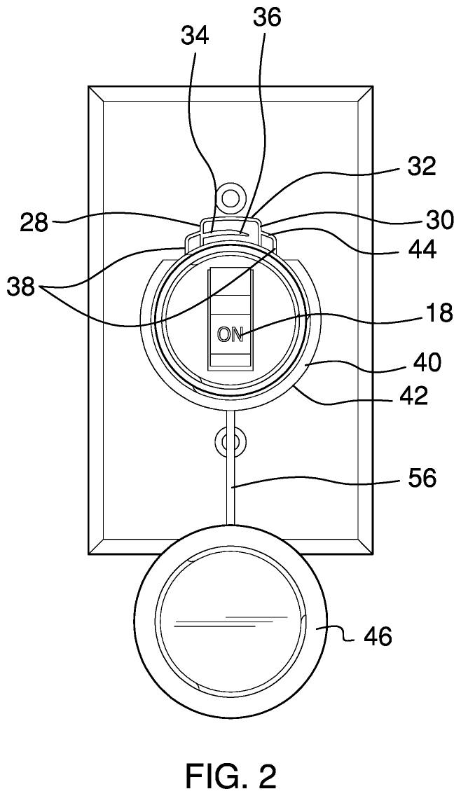

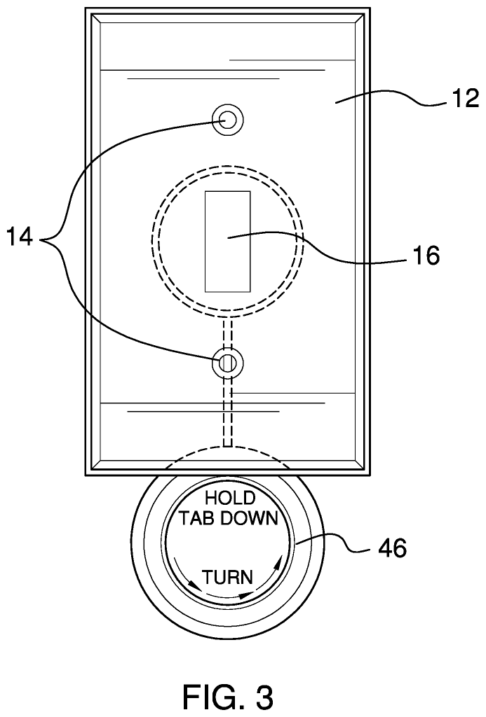

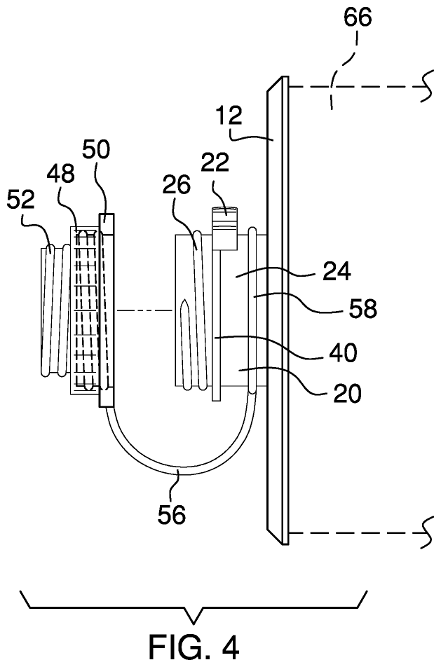

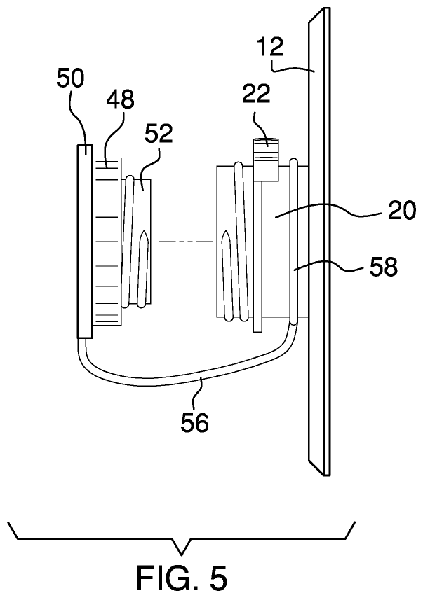

With reference now to the drawings, and in particular to FIGS. 1 through 5 thereof, a new light switch cover plate embodying the principles and concepts of an embodiment of the disclosure and generally designated by the reference numeral 10 will be described.

As best illustrated in FIGS. 1 through 5, the childproof light switch cover apparatus 10 generally comprises a cover plate 12 configured to engage a standard light switch box. The cover plate 12 may have a pair of countersunk mounting apertures 14 extending therethrough to achieve this engagement. The cover plate 12 has a switch aperture 16 extending therethrough. The switch aperture 16 is dimensioned to receive a switch 18 of the standard light switch box and may be rectangular to accommodate the switch 18 without exposing any more of the standard light switch box.

A tubular extension 20 is coupled to the cover plate 12 around the switch aperture 16. The extension 20 leaves sufficient room for the switch 18 to toggle between the on position and the off position. A locking tab 22 is coupled to the extension 20. The locking tab 22 is coupled to a sidewall 24 of the extension adjacent an outer threaded portion 26 of the extension. The locking tab 22 may comprise a left main arm 28, a right main arm 30, a central crosspiece 32 extending therebetween, and a tongue 34 extending from the left main arm 28 towards the right main arm 30. The tongue 34 may have a tapered distal end 36 to aid in engagement. A pair of angled support arms 38 may be coupled to the left main arm 28 and the right main arm 30 for reinforcement. A stopper rim 40 is coupled to the extension 20 and extends from adjacent each side of the locking tab 22. An outer perimeter 42 of the stopper rim 40 aligns with an upper facet 44 of each of the support arms 38.

A cap 46 has a main portion 48 and a flanged bottom portion 50. The cap 46 is threadingly engageable with the outer threaded portion 26 of the extension and the flanged bottom portion 50 is selectively engageable with the locking tab 22 to prevent the cap 46 from rotating to disengage from the extension 20. The bottom portion 50 may encompass the stopper rim 40 to correctly align the cap 46 with the tongue 34. The locking tab 22 is substantially flexible to be depressed and disengage from the cap 46 to allow the cap to rotate freely and be removed. The cap 46 may have a male threaded portion 52 coupled to the main portion 48. The male threaded portion 52 is selectively engageable with an internal threading 54 of the extension to engage the cap 46 with the extension 20 without engaging the locking tab 22. The apparatus 10 may thus be used with or without a childproof process to uncover the switch 18. A diameter of the male threaded portion 52 may be less than a diameter of the main portion 48 to all the main threaded portion 50 to be more comfortably gripped.

A tether 56 is rotatably coupled to the cap 46 and has a loop portion 58 to selectively engageable the extension 20. The loop portion 58 may sit between the cover plate 12 and the stopper rim 40. The tether 56 prevents the cap from falling when disengaged from the extension 20.

In use, the cover plate 12 is coupled to the light switch box with the switch 18 extending through the switch aperture 16. The cap 46 may then be engaged either with the outer threaded portion 26 or the internal threading 54 of the extension.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A childproof light switch cover apparatus comprising:
a cover plate, the cover plate being configured to engage a light switch box, the cover plate having a switch aperture extending therethrough, the switch aperture being dimensioned to receive a switch of the standard light switch box;
a tubular extension coupled to the cover plate, the extension being coupled around the switch aperture;
a locking tab coupled to the extension, the locking tab being coupled to a sidewall of the extension adjacent an outer threaded portion of the extension; and
a cap having a main portion and a flanged bottom portion, the cap being threadingly engageable with the outer threaded portion of the extension, the locking tab being substantially flexible to be depressed and allow the cap to rotate freely.

2. The childproof light switch cover apparatus of claim 1 further comprising a stopper rim coupled to the extension, the stopper rim extending from each adjacent side of the locking tab.

3. The childproof light switch cover apparatus of claim 1 further comprising a tether coupled to the cap, the tether being rotatably coupled to the cap and having a loop portion, the loop portion being selectively engageable with the extension to prevent the cap from falling when disengaged from the extension.

4. The childproof light switch cover apparatus of claim 1 further comprising the switch aperture being rectangular.

5. (canceled)

6. The childproof light switch cover apparatus of claim 1 further comprising the cap having a male threaded portion coupled to the main portion, the male threaded portion being selectively engageable with an internal threading of the extension to engage the cap with the extension without engaging the locking tab.

7. The childproof light switch cover apparatus of claim 6 further comprising a diameter of the male threaded portion being less than a diameter of the main portion.

8. The childproof light switch cover apparatus of claim 1 further comprising the locking tab comprising a left main arm, a right main arm, a central crosspiece extending therebetween, and a tongue extending from the left main arm towards the right main arm.

9. The childproof light switch cover apparatus of claim 8 further comprising the tongue having a tapered distal end.

10. The childproof light switch cover apparatus of claim 8 further comprising a pair of angled support arms coupled to the left main arm and the right main arm.

11. A childproof light switch cover apparatus comprising:
a cover plate, the cover plate being configured to engage a light switch box, the cover plate having a switch aperture extending therethrough, the switch aperture being dimensioned to receive a switch of the light switch box;
a tubular extension coupled to the cover plate, the extension being coupled around the switch aperture;
a locking tab coupled to the extension, the locking tab being coupled to a sidewall of the extension adjacent an outer threaded portion of the extension;
a stopper rim coupled to the extension, the stopper rim extending from each adjacent side of the locking tab;
a cap having a main portion and a flanged bottom portion, the cap being threadingly engageable with the outer threaded portion of the extension, the locking tab being substantially flexible to be depressed and allow the cap to rotate freely, the cap having a male threaded portion coupled to the main portion, the male threaded portion being selectively engageable with an internal threading of the extension to engage the cap with the extension without engaging the locking tab; and
a tether coupled to the cap, the tether being rotatably coupled to the cap and having a loop portion, the loop portion being selectively engageable with the extension to prevent the cap from falling when disengaged from the extension.

12. The childproof light switch cover apparatus of claim 11 further comprising a diameter of the male threaded portion being less than a diameter of the main portion.

13. The childproof light switch cover apparatus of claim 11 further comprising the locking tab comprising a left main arm, a right main arm, a central crosspiece extending therebetween, and a tongue extending from the left main arm towards the right main arm.

14. The childproof light switch cover apparatus of claim 13 further comprising the tongue having a tapered distal end.

15. The childproof light switch cover apparatus of claim 13 further comprising a pair of angled support arms coupled to the left main arm and the right main arm.
